(19) United States
(12) Patent Application Publication
(10) Pub. No.: US 2011/0172963 A1
(43) Pub. Date: Jul. 14, 2011

(54) Methods and Apparatus for Predicting the Performance of a Multi-Tier Computer Software System

(75) Inventors: Yu Gu, Plainsboro, NJ (US); Ke Pan, Brooklyn, NY (US); Atul Singh, Princeton, NJ (US); Guofei Jiang, Princeton, NJ (US)

(73) Assignee: NEC LABORATORIES AMERICA, INC., Princeton, NJ (US)

(21) Appl. No.: 13/004,069

(22) Filed: Jan. 11, 2011

Related U.S. Application Data
(60) Provisional application No. 61/294,593, filed on Jan. 13, 2010.

(51) Int. Cl. G06F 19/00

(52) U.S. Cl. 702/182

(57) ABSTRACT

A method and system for predicting the performance of a multi-tier computer software system operating on a distributed computer system, sends client requests to one or more tiers of software components of the multi-tier computer software system in a time selective manner; collects traffic traces among all the one or more tiers of the software components of the multi-tier computer software system; collects CPU time at the software components of the multi-tier computer software system; infers performance data of the multi-tier computer software system from the collected traffic traces; and determines disk input/output waiting time from the inferred performance data.

### RELATED APPLICATION

This application claims the benefit of U.S. Provisional Application No. 61/294,593, filed Jan. 13, 2010, the entire disclosure of which is incorporated herein by reference.

### FIELD

The present disclosure relates to distributed computing. More specifically, the present disclosure relates to methods and apparatus for predicting the performance of a muti-tier computer software system running on a distributed computer system.

### BACKGROUND

A multi-tier system or architecture is a computer software system whose functions are implemented through cooperation of several software components running on distributed computer hardware. Many Internet-based software services, such as ecommerce, travel, healthcare, and finance sites, are built using the multi-tier software architecture. In such an architecture, a front end web server (e.g., Apache server or Microsoft's IIS server) accepts user requests and forwards them to the application tier (e.g., Tomcat or JBoss server) where the request is processed and necessary information is stored in a storage tier (e.g., MySQL, DB2, or Oracle databases).

A key challenge in building multi-tier software services is to be able to meet the service's performance requirement. The design process usually involves answering questions such as, “How many servers are needed in each tier to provide average response time of 50 ms for 90% of requests?” Once built, the designers then constantly worry if the current architecture can meet the performance requirements of the future, for example, when request workload increases due to the popularity of the service or extreme events such as the Slashdot effect or massive DoS attacks. Scaling up performance of a complex multi-tier application is a non-trivial task but a common first attempt solution is to throw more hardware resources and to partition the workload.

Cloud computing infrastructures, such as Amazon's EC2 and Google's AppEngine, have made scaling up hardware resources available to applications both inexpensive and fast. For example, Animoto scaled up its EC2 instances from 300 to 3000 within three days. Such elastic infrastructures allow applications to be highly scalable, however, the designers must carefully decide where to place these available resources to achieve the maximum benefit in terms of application performance. To answer such questions, it is critical to know the performance improvement (or lack thereof, suggesting a bottleneck) when the resources assigned to the service are scaled up.

The ability to accurately predict the performance, but without actually building the service at scale, can significantly help the designers of such services in delivering high performance. However, predicting performance of multi-tier systems is challenging because of the complex nature of multi-tier systems. For example, typical processing of requests require complex interactions between different tiers. Moreover, these applications have non-trivial internal logic, e.g., they use caching and enforce hard limits on the number of maximum threads. Finally, in a scaled-up deployment, new interactions or bottlenecks may arise, or existing bottlenecks may shift between different tiers.

Many statistical approaches (black-box approaches) have been proposed that attempt to build a probabilistic model of the whole system by inferring the end-to-end processing paths of requests, such as remote procedure call (RPC), system-call, or network log files, which are then used to predict the performance. These techniques are generic but lack high accuracy.

White-box approaches or techniques use system specific knowledge to improve the accuracy at the expense of generality. Magpie requires modifications in middleware, application, and monitoring tools in order to generate the event logs that can be understood and analyzed by Magpie. Pinpoint tags each request with an ID by modifying middleware, and then correlates failed requests with the components that caused the failure by means of clustering and statistical techniques. Standust also uses an ID for each request by modifying middleware, puts all the logs in a database, and uses database techniques to analyze the application behavior.

Gray-box approaches provide a middle ground: they are less intrusive compared to white-box approaches but are more accurate than black-box approaches. For example, vPath proposes a new approach to capture the end-to-end processing path of a request in multi-tier systems. The key observation of vpath is that a separate thread is assigned for processing individual requests in multi-tier applications. This allows vPath to associate a thread to the system call related to a given network activity and hence accurately link various messages corresponding to a single client request.

Existing methods either model or simulate each tier of a multi-tier system separately. Since processing at different tiers is highly correlated, these approaches are limited in accuracy.

Accordingly, improved methods and apparatus are needed for modeling or determining the performance of a multi-tier system.

### SUMMARY

Method are disclosed for predicting the performance of a multi-tier computer software system operating on a distributed computer system. In one embodiment, the method comprises sending client requests to tiers of software components of the multi-tier computer software system in a time selective manner; collecting traffic traces among all the tiers of the software components of the multi-tier computer software system; collecting CPU time at the software components of the multi-tier computer software system; and inferring performance data of the multi-tier computer software system from the collected traffic traces.

Also disclosed are systems for predicting the performance of a multi-tier computer software system operating on a distributed computer system. In one embodiment, the system comprises a request generator for sending client requests to software components of the multi-tier computer software system, in a time selective manner; a traffic monitor for collecting traffic traces among all the tiers of the software components of the multi-tier computer software system; a CPU monitor for collecting central processing unit (CPU) time at the software components of the multi-tier computer software system; and a processor executing instructions for inferring performance data of the multi-tier computer software system from the collected traffic traces.

### BRIEF DESCRIPTION OF THE DRAWINGS

FIG. 1 is a block diagram of an exemplary embodiment of a small scale controlled environment for determining the key performance features of a multi-tier computer software system or architecture (system).

FIG. 2 is a flow chart illustrating the method of the present disclosure for predicting the performance of a multi-tier computuer software system using the environment of FIG. 1.

FIG. 3 is a block diagram of an apparatus for inferring performance data of the multi-tier computer software system from the collected traffic traces in accordance with the method of FIG. 2.

FIG. 4 is a flow chart of a method for inferring the message traces captured at different tiers of the multi-tier computer software system using the apparatus of FIG. 3.

FIG. 5 is a diagram of a state machine that will determine the state of the tier software components in accordance with the method of FIG. 2.

FIG. 6 is a block diagram of an exemplary embodiment of one of the computers that can be used for implementing the methods of the present disclosure.

### DETAILED DESCRIPTION

The method of the present disclosure attempts to identify main parameters that determine the performance characteristics of a multi-tier computer software system or architecture. As described earlier, the various functions of the computer software system are implemented through cooperation of several software components (tiers) running on distributed computer system, e.g., two or more servers or computers communicating with one another via a computer network. These performance parameters include interactions between software components, the temporal correlation of these interactions, central processing unit (CPU) time and input/output (IO) waiting time of these components to complete processing of requests. These performance parameters can be used to predict the performance of the multi-tier computer software system in new environments through existing methods such as queuing theory or simulation.

The method of the present disclosure determines the key performance features of a multi-tier computer software system, including computer network traffic interactions between software components and their temporal correlations, CPU time at each component and IO waiting time at each component, through a black-box approach by exploiting a small scale controlled environment, i.e., an environment containing a substantially fewer number of software component tiers than a typical multi-tier computer software system. In this small scale controlled environment, one can control the input (the requests) to the system so that each request is separated from other requests in time. The parameters produced by the invention can be used by existing techniques, such as queuing theory and simulation, to accurately predict multi-tier system's performance in new, potentially large computing infrastructures without actual deployment of the system. The results can be used for resource provisioning, capacity planning and trouble shooting.

The method generally includes a data collection process and an inference process. The data collection process collects computer network traffic traces between each pair of software components and the CPU time required by the request at each software component. The inference process infers the correlation of interaction traffic between software components and the sojourn time of each request at the components. This sojourn time includes both CPU time and disk IO waiting time. Then, by extracting the CPU time, the disk IO waiting time is obtained.

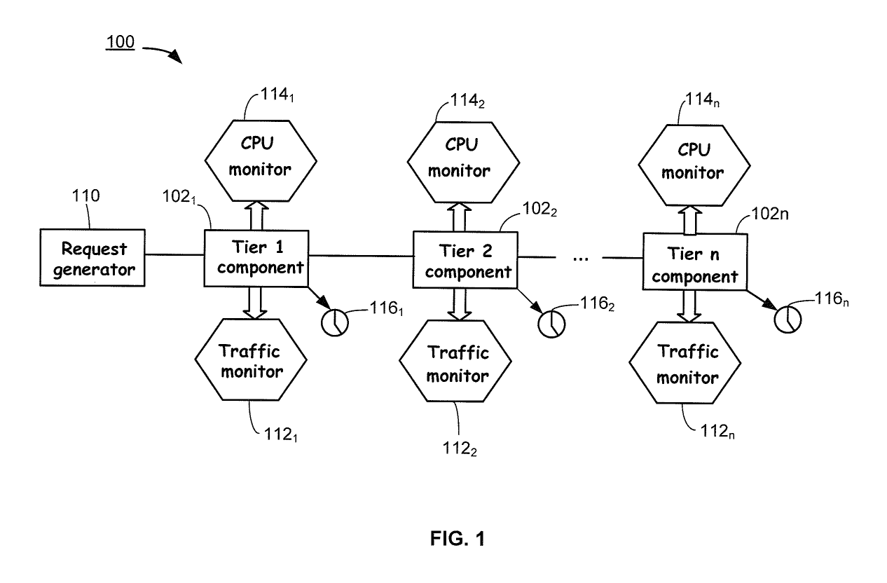

FIG. 1 is a block diagram of an exemplary embodiment of a small scale controlled environment 100 using for predicting the performance features of a multi-tier computer software system or architecture (system). The environment 100 includes a plurality of tier software components (e.g., multiple Apache web servers, Tomcat servers, and database servers such as MySQL) 102₁, 102₂, 102ₙ, which form the multi-tier computer software system. Each of the tier software components 102₁, 102₂, 102ₙ runs on a separate physical machine (a server computer) and/or on a separate virtual machine, i.e., a software implemenation of a computer operating on top of a software layer of a host computer. The number of tier software components is substantially less than in a typical multi-tier computer software system.

The environment 100 of FIG. 1 further includes a request generator 110 for generating client requests at a controlled rate to the system. The request generator 110 can be, without limitation, an HP LoadRunner system from Hewlett-Packard running on a computer separate from the server or host computers. Each request traverses all the tier software components 102₁, 102₂, 102ₙ and can enter and exit the system though tier software component 102_{1.} The request generator 110 acts like or simulates a client computer of the multi-tier system. The requests are typically sent automatically by the request generator 110 at a user selected rate. The rate at which the requests are sent, is selected so that execution of a previous request does not interfere with the execution of a current request or in other words, so that the requests are separated from one another in time. A plurality of traffic monitors 112₁, 112₂, 112ₙ, one for each tier software component, are provided for capturing all data traffic to and from their respective tier software components. Each traffic monitor records a sending time and a receiving time of the data. A plurality of CPU monitors 114₁, 114₂, 114ₙ, one for each tier software component, are provided for recording the CPU cycle used at their respective tier software components. The traffic and CPU monitors may be implemented in hardware, software, or any combination thereof. For example, but not a limitation, the traffic monitor can be a conventional packet analyzer, such as tcpdump, and the CPU monitor can be a conventional resource monitor application. A plurality of clocks 116₁, ¹¹6₂, 116ₙ, one for each tier software component, are provided for obtaining send and receive timings by inference from the data packets. The clocks of each tier are synchronized with one another. The send and receive timings are then used for temporal correlations of the data packets at their respective tier software components.

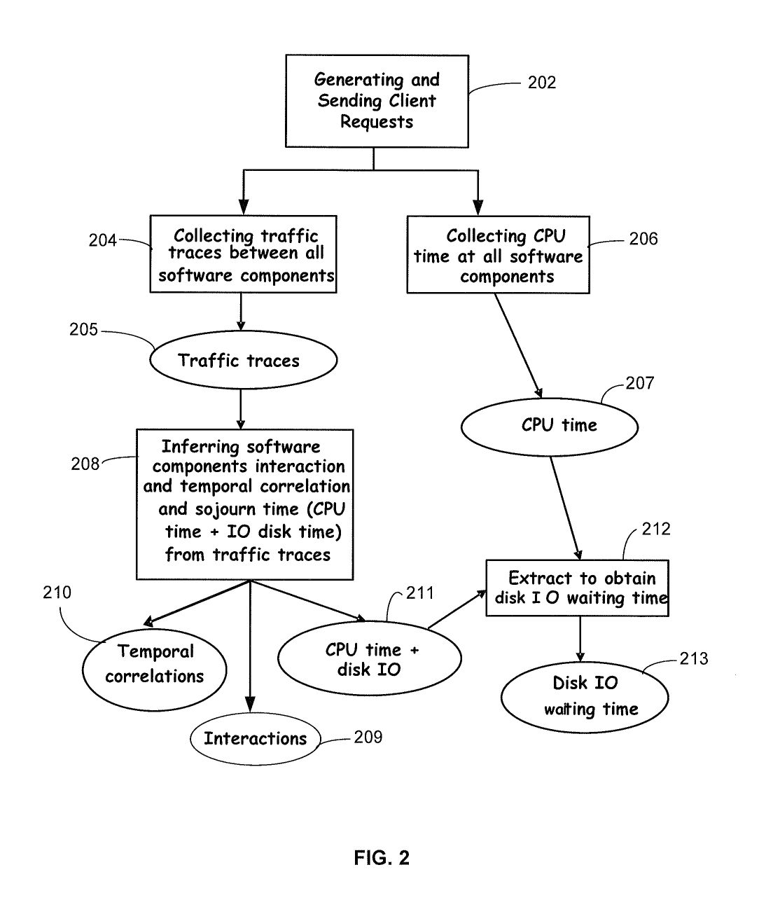

FIG. 2 is a flow chart illustrating the method performed using the environment of FIG. 1, for determining the performance parameters of a multi-tier computer software system. In block 202, the request generator generates client requests that are sent to the system at a rate which can be controlled by the user. As the requests are processed by the system, the traffic monitors collect network traffic traces between all the tier software components in block 204, while the CPU monitors collect the CPU time at all the software components in block 206.

In block 208 of FIG. 2, the performance parameters of the multi-tier computer software system are inferred from the traffic traces 205 and CPU time 207 collected in blocks 204 and 206. These performance parameters can include interactions (e.g., a series of message exchanges between different tiers) between the tier software components 209, temporal correlation of the interactions 210, and the sojourn time 211 at each tier software component. The sojourn time 211 is the sum of CPU time 207 and disk I/O completion time 213.

In block 212 of FIG. 2, CPU time 207 is subtracted from the sojourn time 211 obtained in block 208, to obtain the disk IO completion time 213 at each tier software component.

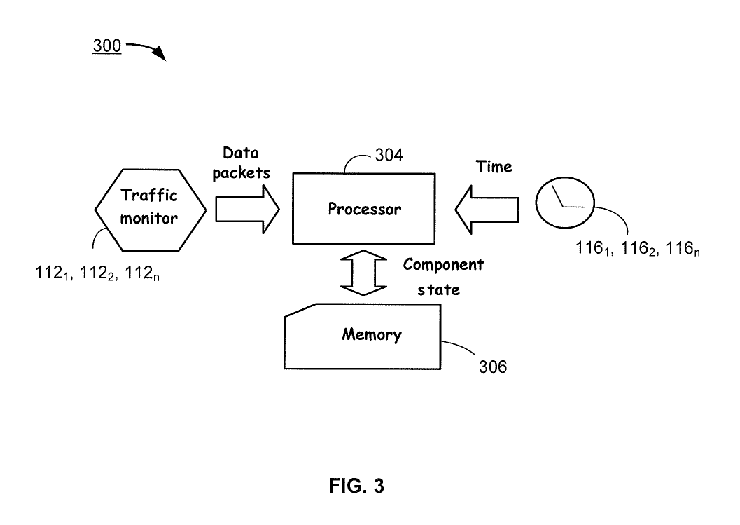

FIG. 3 is a block diagram of an “inferring” computer 300 for performing the processes of blocks 208 and 212 of the method of FIG. 2. The computer 300 includes a CPU 304 and a memory 306. The CPU 304 receives as an input the data collected by the traffic monitors 112₁, 112₂, 112ₙ of FIG. 1 which includes data packets sent to and from the corresponding tier software components. The CPU 304 also receives as an input clock data from the clocks 116₁, 116₂, 116ₙ, which record when the packets are sent and captured by their corresponding traffic monitor. The CPU 304 extracts source, destination and size information of each captured packet, and performs tier software component state inference and outputs the sojourn time of requests at the tier software components. The memory 306 stores the intermediate and final inference data generated by the CPU 304.

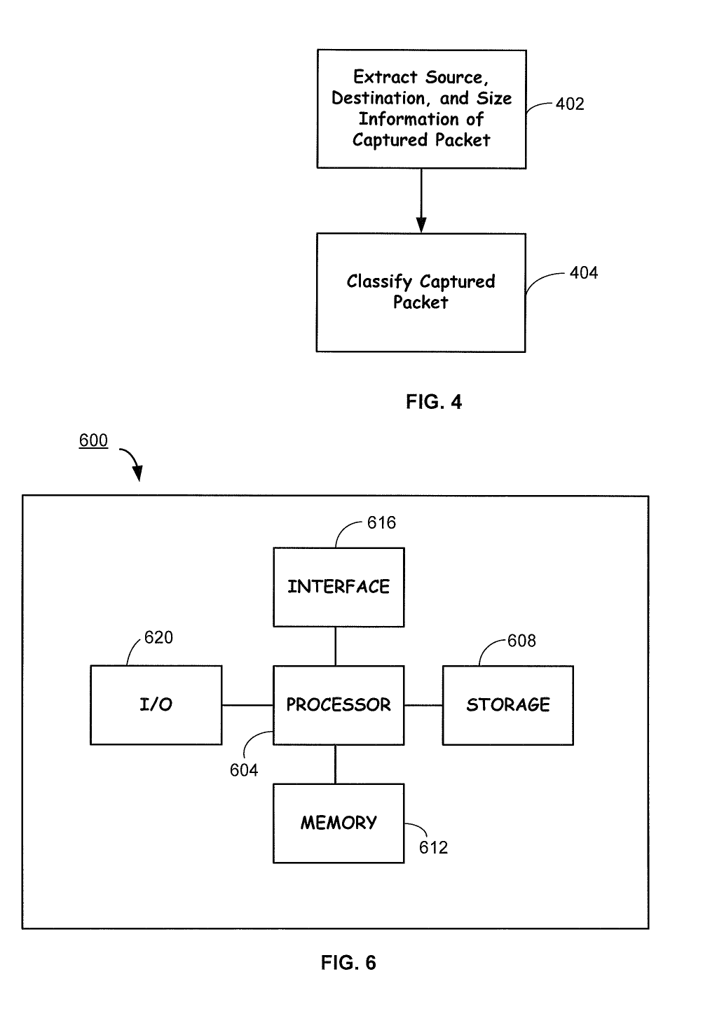

FIG. 4 is a flow chart of a method for inferring the performance features of the multi-tier computer software system using the inferring computer of FIG. 3. In block 402, the CPU 304 uses the traffic data collected by the traffic monitors 112₁, 112₂, 112ₙ and the clock data provided by the clocks 116₁, 116₂, 116ₙ to extract source, destination, and size information of the captured packet. In block 404, the CPU 304 uses the address of the tier software component to classify the packet into one of the following classes: request from client; response to client; request to the server (i.e., the physical or virtual machine on which the tier software component runs); and response to the server. A client represents either the multitier system's end user or a node in a downstream tier (e.g. for tier 1 software component 102₁, the tier 2 software component 102₂ would be the downstream tier and the request generator 110 would be the upstream tier. Similarly, for the tier 2 software component 102₂, the tier n software component 102ₙ would be the downstream tier while tier 1 software component 102₁ would be the upstream tier). A server represents a node in the upstream tier. The classes will determine the state of the tier software component according to a state machine running on CPU 304 of FIG. 3, which infers thread activity. More specifically, a state machine running on CPU 304, is created for each tier software component to infer the time spent in CPU and disk I/O waiting, as shown in FIG. 2, blocks 211 and 212. The CPU monitor provides data about the CPU resources consumed by each request. The total time spent in a “busy” state is inferred by the state machine using the traffic monitor data. The I/O waiting time is obtained by subtracting the CPU time from the total time spent in the busy state.

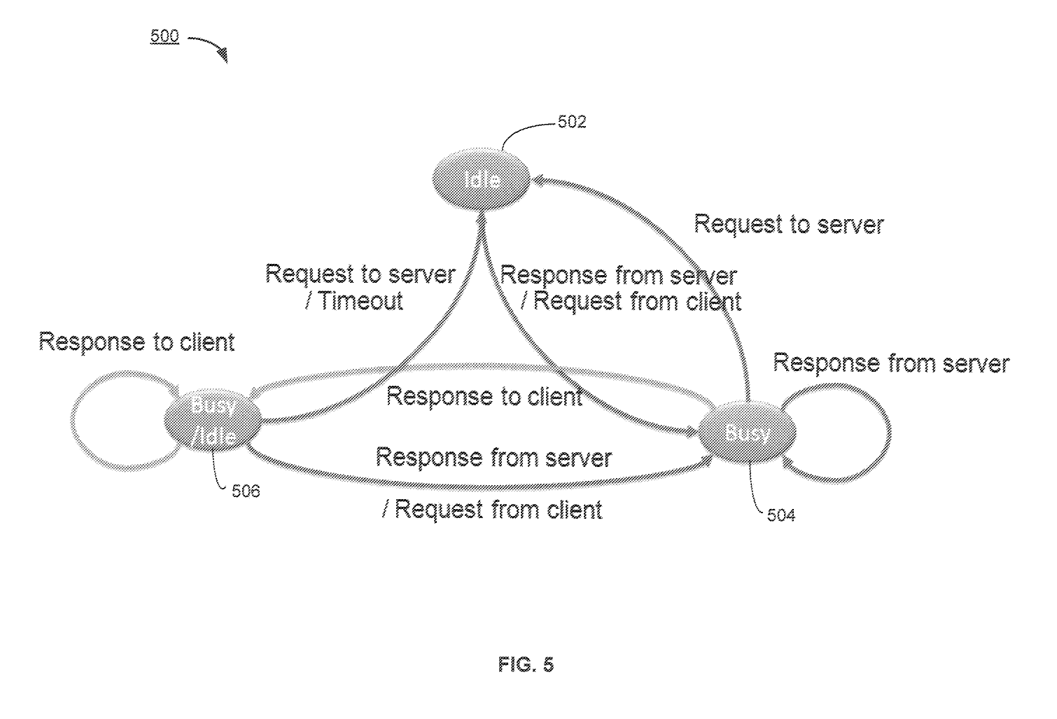

FIG. 5 is a diagram of the state machine 500 of a tier. The state machine includes an idle state 502, a busy state 504, and a busy/idle state 506. The idle state 502 indicates that there is no request in the corresponding tier software component or a request is not currently served at this component. The busy state 504 indicates that a request is currently served at the corresponding tier software component. The busy/idle state 506 indicates that a request being served at the corresponding tier software component will be determined by the next packet.

The initial state of the tier software component of interest is set to idle. The state of this tier software component will change according to the captured packet and the state machine 500. For example, when the tier software component is at the idle state 502, and a request from a client arrives, its state will change to the busy state 504. When the tier software component is at the busy/idle state 506, the current tier software component state is determined by the next packet. If the next packet is a request to a server, the current state will be determined as the busy state 504. If the next packet is a response from the server or a request from the client, the current state will be determined as the idle state 502.

The methods of the present disclosure may be performed by appropriately programmed computers, the configurations of which are well known in the art. The client, server, and the inferring computers can each be implemented, for example, using well known computer CPUs, memory units, storage devices, computer software, and other modules. A block diagram of a non-limiting embodiment of a computer (client or server computer) is shown in FIG. 6 and denoted by reference numeral 600. The computer 600 includes, without limitation, a processor 604 which controls the overall operation of computer 600 by executing computer program instructions corresponding to the methods of the present disclosure, e.g., the tier component software, and the CPU and traffic monitors of the server or host computer, or the request generator of the client computer. The computer program instructions can be stored in a storage device 608 (e.g., magnetic disk) and loaded into memory 612 when execution of the computer program instructions is desired. The computer 600 further includes one or more interfaces 616 for communicating with other devices, such as the client, server and/or inferring computers (e.g., locally or via a network). The computer 600 still further includes input/output 620 which represents devices which allow for user interaction with the computer 600 (e.g., display, keyboard, mouse, speakers, buttons, etc.).

One skilled in the art will recognize that an actual implementation of a computer executing computer program instructions corresponding to the methods of the present disclosure, can also include other elements as well, and that FIG. 6 is a high level representation of some of the elements of the computer for illustrative purposes. Further, a computer executing computer program instructions corresponding to the methods of the present disclosure, can be component of a larger apparatus or system. In addition, one skilled in the art will recognize that the methods described herein may also be implemented using dedicated hardware, the circuitry of which is configured specifically for implementing the method. Alternatively, the methods may be implemented using various combinations of hardware and software.

While exemplary drawings and specific embodiments have been described and illustrated herein, it is to be understood that that the scope of the present disclosure is not to be limited to the particular embodiments discussed. Thus, the embodiments shall be regarded as illustrative rather than restrictive, and it should be understood that variations may be made in those embodiments by persons skilled in the art without departing from the scope of the present invention as set forth in the claims that follow and their structural and functional equivalents.

What is claimed is:

1. A method for predicting the performance of a multi-tier computer software system operating on a distributed computer system, the method comprising:
sending client requests to one or more tiers of software components of the multi-tier computer software system executed on a central processing unit (CPU), in a time selective manner;
collecting traffic traces among all the one or more tiers of the software components of the multi-tier computer software system with a traffic monitor;
collecting CPU time at the software components of the multi-tier computer software system with a CPU monitor; and
inferring, in a computer process, performance data of the multi-tier computer software system from the collected traffic traces.

2. The method of claim 1, further comprising generating the client requests with a request generator prior to the sending of the client requests.

3. The method of claim 1, wherein the traffic traces and the CPU time are collected at the same time.

4. The method of claim 1, wherein the traffic traces and the CPU time are collected at the same time, as the client requests are sent to the one or more tiers of the software components of the multi-tier computer software system.

5. The method of claim 1, wherein the time selective manner separates the client requests from one another in time so that execution of the client requests by the one or more tiers of the software components of the multi-tier computer software system, do not interfere with one another.

6. The method of claim 1, wherein the inferred performance data include interactions among the one or more tiers of the software components of the multi-tier computer software system.

7. The method of claim 6, wherein the inferred performance data include temporal correlations of the interactions among the one or more tiers of the software components of the multi-tier computer software system.

8. The method of claim 1, wherein the inferred performance data include sojourn time at each of the one or more tiers of the software components of the multi-tier computer software system.

9. The method of claim 8, further comprising determining disk input/output waiting time from the sojourn time.

10. The method of claim 1, further comprising determining disk input/output waiting time from the inferred performance data.

11. A system for predicting the performance of a multi-tier computer software system operating on a distributed computer system, the system comprising:
a request generator for sending client requests to one or more tiers of software components of the multi-tier computer software system, in a time selective manner;
a traffic monitor for collecting traffic traces among all the one or more tiers of the software components of the multi-tier computer software system;
a CPU monitor for collecting central processing unit (CPU) time at the software components of the multi-tier computer software system; and
a processor executing instructions for inferring performance data of the multi-tier computer software system from the collected traffic traces.

12. The system of claim 11, wherein the traffic traces and the CPU time are collected at the same time.

13. The system of claim 11, wherein the traffic traces and the CPU time are collected at the same time, as the client requests are sent to the one or more tiers of the software components of the multi-tier computer software system.

14. The system of claim 11, wherein the time selective manner separates the client requests from one another in time so that execution of the client requests by the one or more tiers of the software components of the multi-tier computer software system, do not interfere with one another.

15. The system of claim 11, wherein the inferred performance data includes interactions among the one or more tiers of the software components of the multi-tier computer software system.

16. The system of claim 15, wherein the inferred performance data further includes temporal correlations of the interactions among the one or more tiers of the software components of the multi-tier computer software system.

17. The system of claim 11, wherein the inferred performance data includes sojourn time at each of the one or more tiers of the software components of the multi-tier computer software system.

18. The system of claim 17, further comprising determining disk input/output waiting time from the sojourn time.

19. The system of claim 11, wherein the processor executes further instructions for determining disk input/output waiting time from the inferred performance data.
